(19) United States
(12) Patent Application Publication
(10) Pub. No.: US 2008/0083197 A1
(43) Pub. Date: Apr. 10, 2008

(54) Decoration buckle for cinches

(75) Inventor: Ju-Sung Chang, Nantou County (TW)

Correspondence Address: Ju-Sung Chang, P.O. BOX 44-2049, Taipei, 10668, omitted

(73) Assignee: Jone-Shou Industrial Co., Ltd.

(21) Appl. No.: 11/543,051

(22) Filed: Oct. 5, 2006

(51) Int. Cl. B68C 1/00

(52) U.S. Cl. 54/23

(57) ABSTRACT

A decoration buckle for cinches includes a straight end pivotably connected to an end of a cinch and a frame is connected to the straight end. A tongue has one end pivotably connected to the straight end and the other end of the tongue rests on the frame. At least one pattern is formed on the frame and composed of bosses extending from an outer surface of the frame.

### BACKGROUND OF THE INVENTION

(1) Field of the Invention

The present invention relates to a decoration buckle for cinches and includes patterns composed of bosses and notches on the buckle.

(2) Description of the Prior Art

Equitation is an import sport in many countries and is also a legal item in Olympic game. In order to secure the saddles on the back of the house a rear cinch 30 is used and the rear cinch generally is an elongate strap which goes under the belly of the horse and includes at least one buckle which connects the other end of the rear cinch as shown in FIGS. 6 and 7. The conventional rear cinch is simply a strap and the buckle 50 is pivotably connected to an end of the cinch 30. The buckle 50 generally includes a straight end 51 which extends through a passage formed in the end of the cinch 30 and a substantially U-shaped frame 51 is integrally connected to the straight end 51. A tongue has one end pivotably connected to the straight end 51 so that when the other end of the cinch 30 extends through the buckle 50, the tongue 53 extends through one of holes in the cinch 30 to form a locked status. The conventional buckle 50 usually coated with a metal layer which has a smooth and shinny surface. Nevertheless, the simply coating cannot show the value of the buckle 50 and many users want more than a plain buckle.

The present invention intends to provide a decoration buckle for cinches and a pattern is formed on the buckle and can be composed by bosses and notches.

### SUMMARY OF THE INVENTION

The present invention relates to a decoration buckle for cinches and the buckle comprises a straight end pivotably connected to an end of a cinch and a frame is connected to the straight end. A tongue has one end pivotably connected to the straight end and the other end of the tongue rests on the frame. At least one pattern is formed on the frame and composed of bosses extending from an outer surface of the frame.

The primary object of the present invention is to provide a decoration buckle of a cinch wherein the buckle includes a pattern on an outer surface of the buckle so as to increase the value of the cinch.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the decoration buckle of the present invention connected to the cinch;

FIG. 2 is a cross sectional view to show bosses on the buckle of the present invention;

FIG. 3 shows that two side frames are connected on the cinch;

FIG. 4 shows another embodiment of the decoration buckle of the present invention;

FIG. 5 is a cross sectional view to show notches of the pattern of the buckle in FIG. 4 of the present invention;

FIG. 6 shows a conventional cinch tied on a horse, and FIG. 7 shows the conventional buckle.

### DETAILED DESCRIPTION OF THE PREFERRED EMBODIMENT

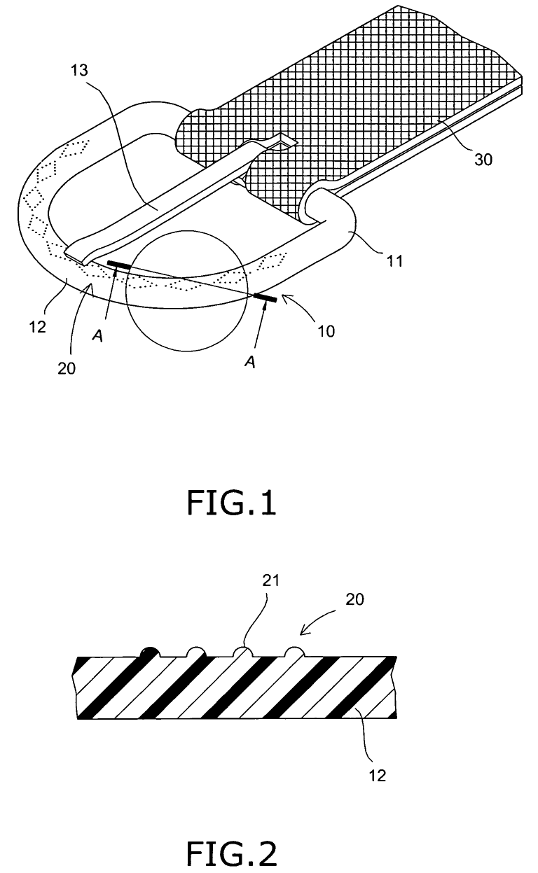

Referring to FIGS. 1 and 2, the decoration buckle 10 for cinches 30 includes a straight end 11 which is pivotably connected to an end of a cinch 30 and a frame 12 is connected to the straight end 11. A tongue 13 has one end pivotably connected to the straight end 11 and the other end of the tongue rests on the frame 12. A pattern 20 is formed on the frame 12 and composed of bosses 21 extending from an outer surface of the frame 12. The bosses 21 of the pattern 20 are arranged to be a plurality of diamond-shaped patterns.

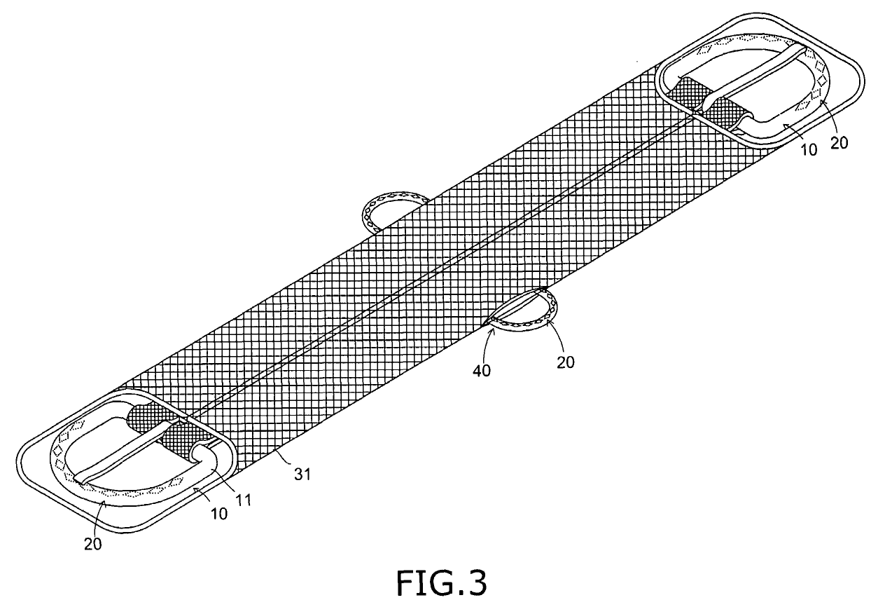

As shown in FIG. 3 which shows another embodiment of the cinch 31 wherein two semi-circular frames 40 are connected on two sides of the cinch 31 and each semi-circular frame 40 has the pattern 20 formed thereon.

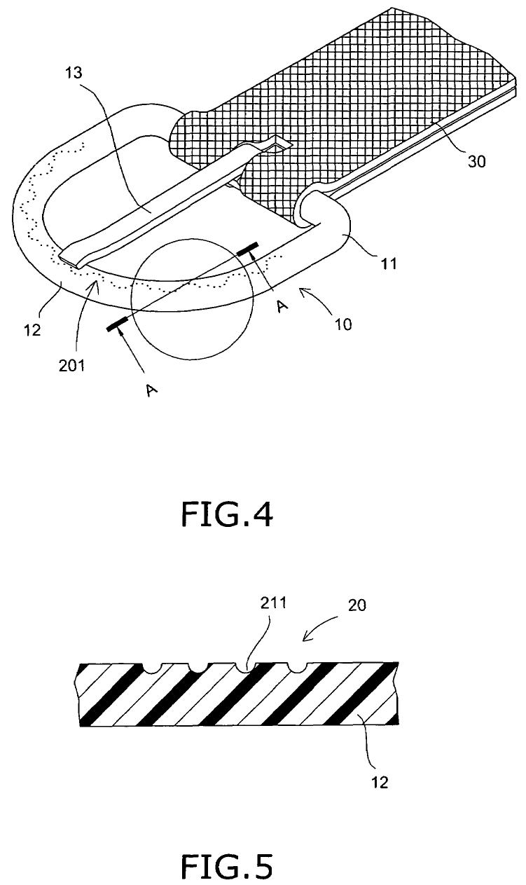

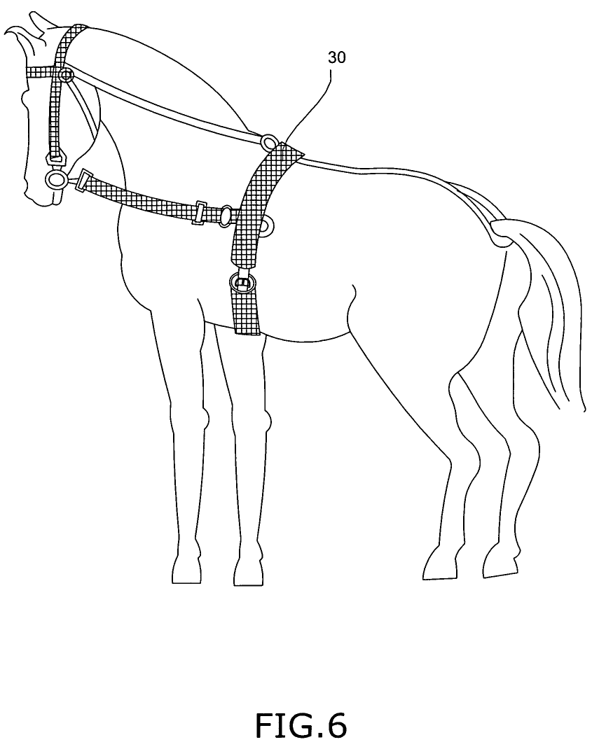

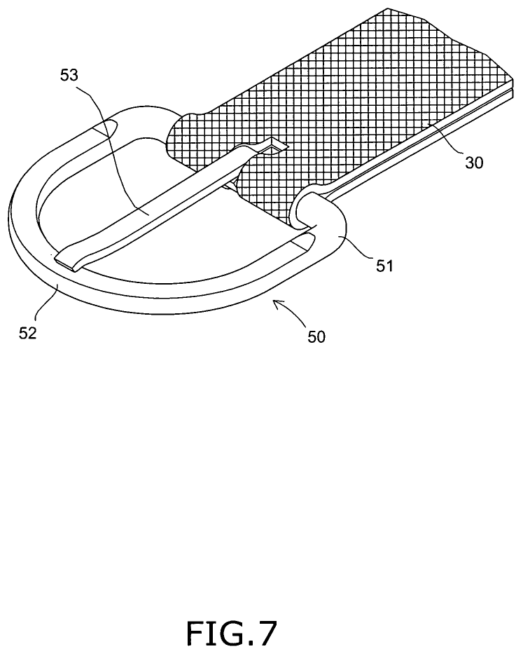

FIGS. 4 and 5 show another embodiment of the decoration buckle 10 of the present invention, wherein the pattern 201 of the frame 12 includes notches 211 defined in the outer surface of the frame 12. The notches 211 of the pattern 201 are arranged to be continuous wave-shaped patterns.

While we have shown and described the embodiment in accordance with the present invention, it should be clear to those skilled in the art that further embodiments may be made without departing from the scope of the present invention.

What is claimed is:

1. A decoration buckle for cinches, comprising:
a straight end which is adapted to be pivotably connected to an end of a cinch, a frame connected to the straight end and a tongue having one end pivotably connected to the straight end and the other end of the tongue rested on the frame, at least one pattern formed on the frame and composed of bosses extending from an outer surface of the frame.

2. The buckle as claimed in claim 1, wherein the at least one pattern includes notches defined in the outer surface of the frame.

3. The buckle as claimed in claim 1, wherein the bosses of the at least one pattern are arranged to be a diamond-shaped pattern.

4. The buckle as claimed in claim 2, wherein the notches of the at least one pattern are arranged to be a wave-shaped pattern.
